(19) United States
(12) Patent Application Publication
(10) Pub. No.: US 2026/0229426 A1
(43) Pub. Date: Aug. 6, 2026

(54) KEY STRUCTURE

(71) Applicant: Darfon Electronics Corp., Taoyuan City (TW)

(72) Inventors: Chih-Hung CHIEN, Taoyuan City (TW); Po-Wei TSAI, Taoyuan City (TW)

(73) Assignee: Darfon Electronics Corp., Taoyuan City (TW)

(21) Appl. No.: 19/454,499

(22) Filed: Jan. 21, 2026

Related U.S. Application Data
(60) Provisional application No. 63/747,962, filed on Jan. 22, 2025.

(30) Foreign Application Priority Data
Mar. 3, 2025 (TW) 114107672

(51) Int. Cl. H01H 13/7073; H01H 13/14

(52) U.S. Cl. CPC H01H 13/7073; H01H 13/14; H01H 2215/004; H01H 2221/044; H01H 2227/032; H01H 2235/002; H01H 2235/008

(57) ABSTRACT

A key structure includes a base, a keycap, a restoring force mechanism, and a switch. The keycap is disposed above the base. The restoring force mechanism is disposed between the base and the keycap and includes a spring and a rubber dome. The spring is disposed around the rubber dome. The switch is fixedly disposed between the base and the rubber dome. When the keycap is at an initial position, the keycap is separated from the spring and in contact with the rubber dome. When the keycap is subjected to a pressing force and moves from the initial position toward the base to a transition position, the keycap contacts the spring. When the keycap moves toward the base beyond a triggering position, the rubber dome actuates the switch to generate a trigger signal.

This application claims the benefits of U.S. Provisional application Ser. No. 63/747,962, filed Jan. 22, 2025 and Taiwan application Serial No. 114107672, filed Mar. 3, 2025, the subject matters of which are incorporated herein by reference.

### BACKGROUND OF THE INVENTION

### Field of the Invention

The invention relates in general to a key structure, and more particularly to a key structure with a restoring force mechanism.

### Description of the Related Art

Currently, most key structures use a spring or a rubber dome to provide the required rebound force for the keycap. Generally, the current spring has only a single fixed spring constant. If the spring constant is small, the rebound force provided by the spring is also small, and the resistance when the user presses the keycap is small, allowing the user to press the keycap quickly. However, due to the small rebound force, the time required for the pressed keycap to return to its original position is longer, making such a characteristic unsuitable for rapid and continuous key pressing within a short period.

If the spring constant is large, the rebound force provided by the spring is also large, allowing the pressed keycap to return to its original position within a shorter time. However, the larger rebound force also increases the resistance when the user presses the keycap, requiring greater force to press the keycap, which easily causes finger fatigue. Such a characteristic is also unfavorable for continuous key pressing within a short period.

Therefore, current key structures (whether using springs or rubber domes) cannot provide a mechanism that enables both rapid pressing and rapid rebound of the keycap. Such a mechanism can reduce the degree of finger fatigue when operating keys in certain use scenarios, such as electronic gaming.

### SUMMARY OF THE INVENTION

The present invention relates to a key structure that utilizes a combination of a spring and a rubber dome to provide a restoring force that increases progressively (light-to-heavy), allowing the user to easily and quickly press the keycap, and enabling the keycap to rebound rapidly after being pressed.

According to one aspect of the present invention, a key structure is provided, including a base, a keycap, a restoring force mechanism, and a switch. The keycap is disposed above the base. The restoring force mechanism is disposed between the base and the keycap and includes a spring and a rubber dome. The spring is disposed around the rubber dome. The switch is fixedly disposed between the base and the rubber dome. When the keycap is at an initial position, the keycap is separated from the spring and in contact with the rubber dome. When the keycap is subjected to a pressing force and moves from the initial position toward the base to a transition position, the keycap contacts the spring. When the keycap moves toward the base beyond a triggering position, the rubber dome actuates the switch to generate a trigger signal. Thus, before the keycap reaches the transition position, the spring does not generate any restoring force, and only the force-displacement characteristic of the rubber dome allows the keycap to move toward the base with a smaller pressing force and at a faster speed. After the keycap passes the transition position, the combination of the spring and the rubber dome provides a larger equivalent spring constant, so that the keycap requires a larger pressing force and moves more slowly, thereby achieving the effect of light-to-heavy feedback, rapid pressing, and rapid rebound.

According to another aspect of the present invention, a key structure is provided, including a base, a keycap, a restoring force mechanism, and a switch. The keycap is disposed above the base. The restoring force mechanism is disposed between the base and the keycap and includes a spring and a rubber dome. The spring is disposed around the rubber dome. The switch is fixedly disposed between the base and the rubber dome. When the keycap is at an initial position, the keycap is separated from the rubber dome and in contact with the spring. When the keycap is subjected to a pressing force and moves from the initial position toward the base to a transition position, the keycap contacts the rubber dome. When the keycap moves toward the base beyond a triggering position, the rubber dome actuates the switch to generate a trigger signal. Thus, before the keycap reaches the transition position, the rubber dome does not generate any restoring force, and only the force-displacement characteristic of the spring provides the restoring force, allowing the keycap to move toward the base with a smaller pressing force and faster speed. After the keycap passes the transition position, the combination of the spring and the rubber dome provides a larger equivalent spring constant, so that the keycap requires a larger pressing force and moves more slowly, thereby achieving the effect of light-to-heavy feedback, rapid pressing, and rapid rebound.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic view illustrating a cross-section of a key structure according to an embodiment of the present invention.

FIG. 2 is a graph showing the relationship between pressing travel and pressing force for the spring and the rubber dome, respectively, and for the combination of the spring and the rubber dome shown in FIG. 1.

FIG. 3 is a graph illustrating the relationship between downward pressing resistance and rebound force of a key with rapid rebound simulated based on the combination of the spring and the rubber dome shown in FIG. 1.

FIG. 4 is a schematic view illustrating a cross-section of a key structure according to another embodiment of the present invention.

FIG. 5 is a schematic view illustrating a cross-section of a key structure according to another embodiment of the present invention.

FIG. 6 is a graph showing the relationship between pressing travel and pressing force for the spring and the rubber dome, respectively, and for the combination of the spring and the rubber dome shown in FIG. 4 or FIG. 5.

FIG. 7 is a graph illustrating the relationship between downward pressing resistance and rebound force of a conventional key with rapid rebound.

### DETAILED DESCRIPTION OF THE INVENTION

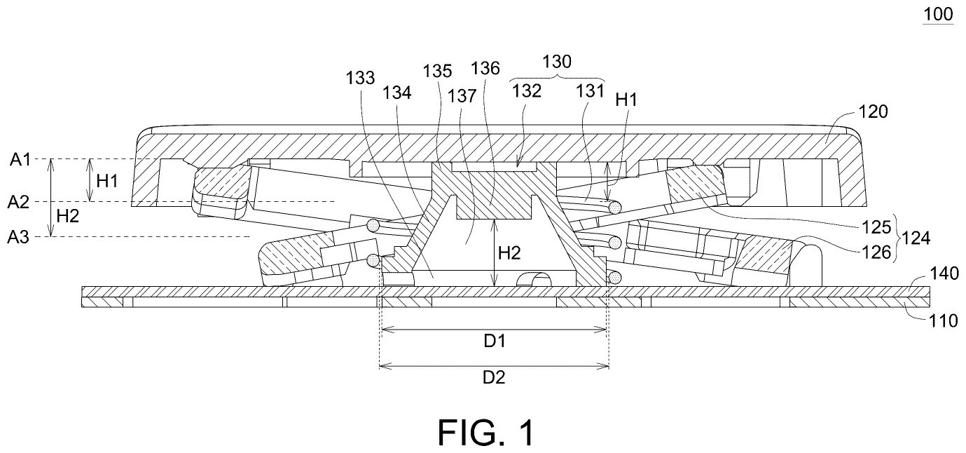

Referring to FIG. 1, a schematic view illustrating a cross-sectional of a key structure 100 according to an embodiment of the present invention is shown. The key structure 100 includes a base 110, a keycap 120, a restoring force mechanism 130, and a switch 140. The keycap 120 is mounted above the base 110 through a supporting structure 124, such as a scissor-type mechanism having an inner linkage 125 and an outer linkage 126, or a butterfly-type mechanism. The restoring force mechanism 130 is disposed between the base 110 and the keycap 120. The restoring force mechanism 130 includes a spring 131 and a rubber dome 132. The spring 131 is disposed around the rubber dome 132. The switch 140 is fixedly disposed between the base 110 and the rubber dome 132.

When the keycap 120 is not pressed, it is positioned at an initial position A1. When a pressing force is applied to the keycap 120, the keycap 120 moves toward the base 110 and actuates the switch 140. As the keycap 120 moves from the initial position A1 toward the base 110, the keycap 120 exerts a pressing force on the restoring force mechanism 130, and the pressing force is transmitted through the restoring force mechanism 130 to the base 110 and the switch 140.

The movement of the keycap 120 toward the base 110 can be divided into the following stages: (1) When the keycap 120 is at the initial position A1, the keycap 120 is separated from the spring 131 and in contact with the rubber dome 132. That is, the height of the rubber dome 132 is greater than that of the spring 131, and the spring 131 and the rubber dome 132 have a height difference H1. The height difference H1 keeps the keycap 120 separated from the spring 131; (2) When a pressing force is applied to the keycap 120, the keycap 120 moves from the initial position A1 toward the base 110. Before the keycap 120 reaches the transition position A2, the keycap 120 remains separated from the spring 131. Accordingly, the spring 131 does not elastically deform with the movement of the keycap 120 relative to the base 110. Only the rubber dome 132 bears the pressing force from the keycap 120 and undergoes elastic deformation. The height difference H1 may be equal to the distance between the initial position A1 and the transition position A2; (3) After the keycap 120 reaches the transition position A2, the keycap 120 contacts the spring 131. At this stage, both the spring 131 and the rubber dome 132 elastically deform as the keycap 120 continues to move toward the base 110 until the keycap 120 reaches a triggering position A3; (4) When the keycap 120 reaches the triggering position A3, the rubber dome 132 actuates the switch 140 to generate a trigger signal. At this stage, the spring 131 and the rubber dome 132 are compressed to a corresponding compressed height. However, the present invention is not limited thereto; alternatively, the key structure 100 may also be designed such that when the keycap 120 is at the triggering position A3, the spring 131 and the rubber dome 132 are not fully compressed and remain elastically deformable.

In one embodiment, the spring 131 is disposed around the rubber dome 132. For example, the spring 131 may be an annular structure formed by winding a spiral metal wire, and includes a hollow portion. The spring 131 may have a single inner diameter or a variable inner diameter, represented as D2, which is not limited thereto. When the spring 131 is unloaded, the spring 131 is in a stretched state; when the spring 131 is subjected to compression, it is compressed and generates a restoring force. The spring 131 may, for example, have a single spring constant, meaning that its deformation amount is proportional to the applied pressing force. However, the present invention is not limited thereto. In another embodiment, the spring 131 may be formed by combining a plurality of elastic bodies with different wire diameters, pitches, or lengths, so that the spring 131 has a variable spring constant. Accordingly, under the same applied pressure, the spring 131 may exhibit different deformation amounts at different stages.

In addition, the rubber dome 132 is disposed within the hollow portion of the spring 131 and located above the switch 140. The top surface of the rubber dome 132 contacts the inner surface of the keycap 120 and is higher than the top surface of the spring 131, thereby defining a height difference H1 between the rubber dome 132 and the spring 131. The rubber dome 132 may, for example, be an arched protrusion structure containing an annular base portion 133, a dome portion 134, and a cylindrical portion 135. The dome portion 134 extends upwardly in an arched shape from the annular base portion 133, and the cylindrical portion 135 extends upwardly from the dome portion 134. Furthermore, a receiving space 137 is formed inside the dome portion 134, and a pressing projection 136 is disposed in the receiving space 137 and extends toward the switch 140 through the top surface of the dome portion 134. The pressing projection 136 is normally separated from the switch 140 by a distance H2. When the keycap 120 is pressed, the dome portion 134 elastically deforms under the pressing force, allowing the pressing projection 136 to contact the switch 140. In one embodiment, the distance H2 between the pressing projection 136 and the switch 140 is relatively small, for example, 1 mm or less, enabling the user to feel a distinct tactile feedback or “click” sensation.

In one embodiment, the outer diameter D1 of the annular base portion 133 is substantially the same as, or within an allowable tolerance range of, the inner diameter D2 of the spring 131. When the spring 131 is fitted around the rubber dome 132, the spring 131 closely abuts the annular base portion 133 to achieve a positioning or limiting effect for the spring 131.

Because the deformation mechanism of the rubber dome 132 differs from the linear deformation of the spring 131, the rubber dome 132 does not exhibit a single fixed spring constant. Generally, in the initial elastic deformation stage, the rubber dome 132 maintains its geometric structure and provides a relatively large spring constant (a first-stage spring constant). After the structure begins to buckle, the rubber dome 132 provides a smaller spring constant (a second-stage spring constant). In the initial deformation stage, the spring constant is large but the deformation amount is small; in the subsequent buckling stage, the spring constant is smaller but the deformation amount is larger. Therefore, during operation, although the user initially feels a greater pressing threshold, the required pressing force decreases thereafter, and the overall elastic energy stored in the deformed rubber dome 132 is not excessive.

Overall, compared with a key using only a spring with a high elastic constant, a key employing only the rubber dome 132 requires a longer recovery time for the keycap 120 to return to its original position, making it unsuitable for rapid successive key pressing in short time. Conversely, if only the spring 131 is used, the rebound force is small, and the keycap 120 also takes longer to return to its original position, again unsuitable for rapid successive key pressing in short time. Therefore, through the dual-stage restoring force mechanism 130 of the present invention, the combination of the spring 131 and the rubber dome 132 provides a two-stage light-to-heavy feedback. This allows the user to press the keycap 120 smoothly and quickly, while enabling the keycap 120 to rebound rapidly, thereby reducing finger fatigue during repetitive key operations, such as in electronic gaming.

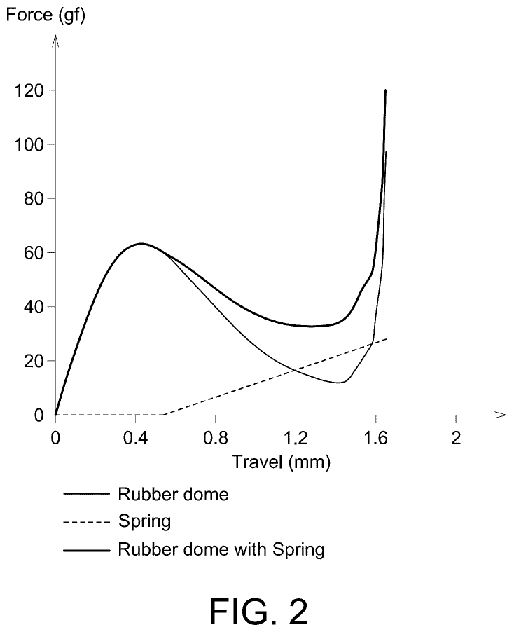

Referring to FIGS. 1 and 2, FIG. 2 illustrates graphs showing the relationship between the pressing displacement and pressing force for the spring 131 and the silicone dome 132 individually, as well as for the combination of the spring 131 and the silicone dome 132. When the keycap 120 is pressed downward from the initial position A1 to the transition position A2—for example, during an initial deformation stage ranging from 0 to 0.5 mm—only the load-displacement characteristic of the rubber dome 132 provides an upward reaction force, while the spring 131 does not contribute any upward force. When the keycap 120 is further pressed beyond the transition position A2 (e.g., beyond 0.5 mm), both the rubber dome 132 and the spring 131 contribute upward forces according to their load-displacement characteristics, and the spring constant of the rubber dome 132 transitions from the first-stage spring constant to the second-stage spring constant. Accordingly, the key structure 100 achieves an increased overall spring constant through the combined action of the rubber dome 132 and the spring 131. For example, during the initial elastic deformation, the rubber dome 132 maintains its geometric structure and provides a relatively large spring constant; after structure buckling deformation begins, the rubber dome 132 provides a smaller spring constant. At this stage, the combination of the rubber dome 132 and the spring 131 increases the overall spring constant, allowing the key structure 100 to achieve a strong rebound force and enabling the keycap 120 to return to its original position in a short time, suitable for rapid successive key pressing.

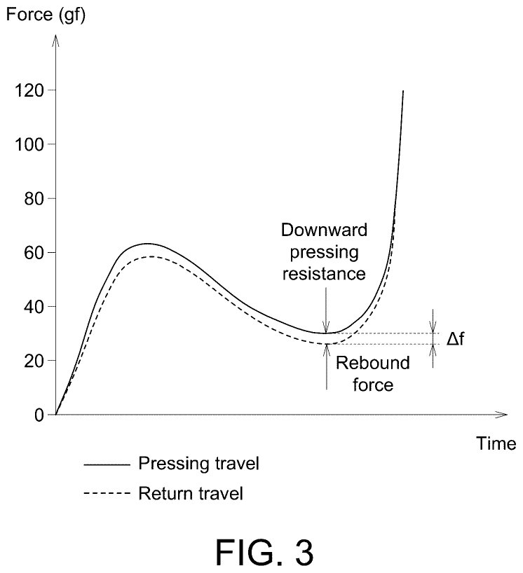

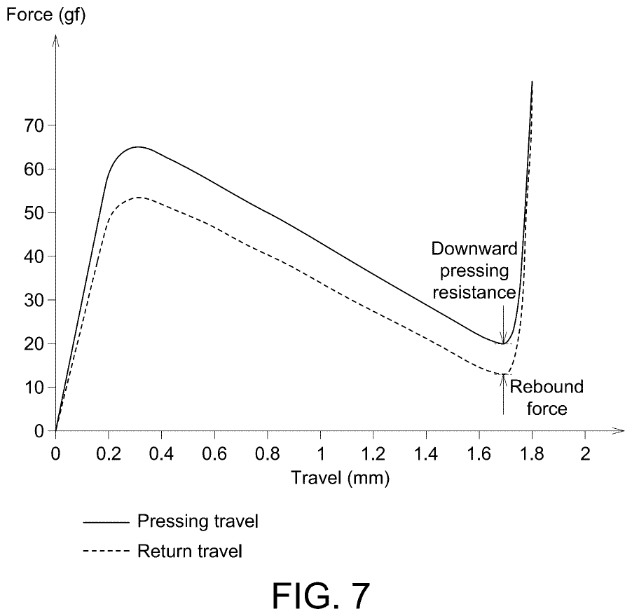

Referring to FIG. 3, a graph showing the relationship between the downward pressing resistance and the rebound force of a fast-rebound key simulated using the combination of the spring 131 and the rubber dome 132 shown in FIG. 1. A conventional fast-rebound key, for example one using a butterfly-type support and a horizontal tension spring as the restoring mechanism (see FIG. 7), typically exhibits a difference of about 5 gram-force (gf) or less between the downward pressing resistance during the pressing travel and the rebound force during its return travel. This difference is smaller than that of a conventional key structure using only a rubber dome 132 to provide restoring force, in which the difference is about 10 gf. Therefore, in the key structure 100 of the present invention, the combination of the rubber dome 132 and the spring 131 (for example, a long dome with a short spring) yields a load-displacement characteristic corresponding to fast rebound behavior. Specifically, the difference Δf between the downward pressing resistance and the rebound force at the lowest point of the key travel is approximately 5 gf or less, thereby reducing the rebound hysteresis effect.

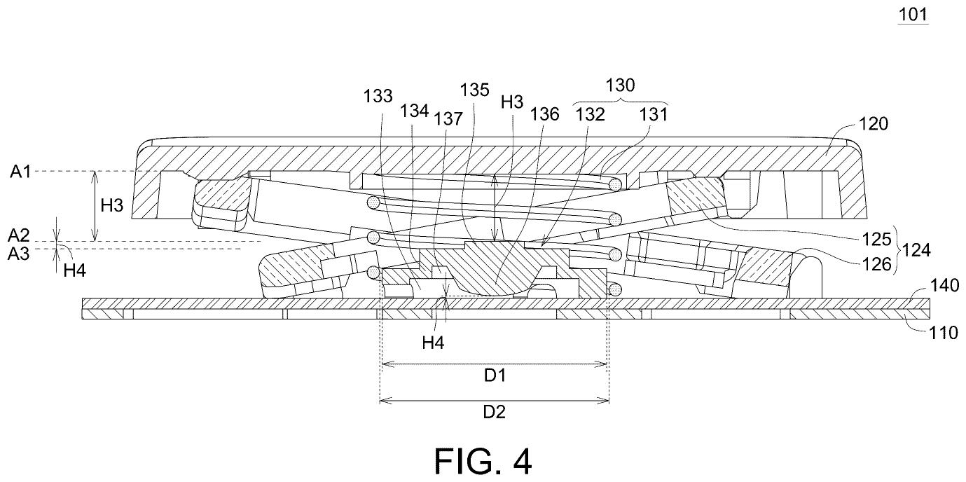

Referring to FIG. 4, a schematic view illustrating a cross-section of a key structure 101 according to another embodiment of the present invention is shown. The key structure 101 includes a base 110, a keycap 120, a restoring force mechanism 130, and a switch 140. The keycap 120 is mounted above the base 110 through a supporting structure 124, such as a scissor-type mechanism having an inner linkage 125 and an outer linkage 126, or a butterfly-type mechanism. The restoring force mechanism 130 is disposed between the base 110 and the keycap 120, and includes a spring 131 and a rubber dome 132. The spring 131 is disposed around the rubber dome 132. The switch 140 is fixedly disposed between the base 110 and the rubber dome 132.

When the keycap 120 is not pressed, it is positioned at an initial position A1. When a pressing force is applied to the keycap 120, the keycap 120 moves toward the base 110 and actuates the switch 140. As the keycap 120 moves from the initial position A1 toward the base 110, the keycap 120 exerts a pressing force on the restoring force mechanism 130, and the pressing force is transmitted through the restoring force mechanism 130 to the base 110 and the switch 140.

The movements of the keycap 120 toward the base 110 can be divided into the following stages: (1) When the keycap 120 is at the initial position A1, the keycap 120 is separated from the rubber dome 132 and in contact with the spring 131. That is, the height of the spring 131 is greater than that of the rubber dome 132. The spring 131 and the rubber dome 132 have a height difference H3. The height difference H3 keeps the keycap 120 separated from the rubber dome 132; (2) When a pressing force is applied to the keycap 120, the keycap 120 moves from the initial position A1 toward the base 110. Before the keycap 120 reaches the transition position A2, the keycap 120 remains separated from the rubber dome 132. Thus, the rubber dome 132 does not elastically deform with the movement of the keycap 120 relative to the base 110. Only the spring 131 bears the pressing force from the keycap 120 and undergoes elastic deformation. The height difference H3 corresponds to the distance between the initial position A1 and the transition position A2; (3) After the keycap 120 reaches the transition position A2, the keycap 120 contacts the rubber dome 132. At this stage, both the spring 131 and the rubber dome 132 elastically deform as the keycap 120 continues to move toward the base 110 until the keycap 120 reaches a triggering position A3; (4) When the keycap 120 reaches the trigger position A3, the rubber dome 132 actuates the switch 140 to generate a trigger signal. At this stage, the spring 131 and the rubber dome 132 are compressed to a corresponding compressed height. However, the present invention is not limited thereto; alternatively, the key structure 100 may also be designed such that, when the keycap 120 is at the trigger position A3, the spring 131 and the rubber dome 132 are not fully compressed and remain elastically deformable.

In one embodiment, the spring 131 is disposed around the rubber dome 132. For example, the spring 131 may be an annular structure formed by winding a spiral metal wire, and includes a hollow portion. The spring 131 may have a single inner diameter or a variable inner diameter, represented as D2, which is not limited thereto. When the spring 131 is unloaded, the spring 131 is in a stretched state; when the spring 131 is subjected to compression, it is compressed and generates a restoring force. The spring 131 may, for example, have a single spring constant, meaning that its deformation amount is proportional to the applied pressing force. However, the present invention is not limited thereto. In another embodiment, the spring 131 may be formed by combining a plurality of elastic bodies with different wire diameters, pitches, or lengths, so that the spring 131 has a variable spring constant. Accordingly, under the same applied pressure, the spring 131 may exhibit different deformation amounts at different stages.

In addition, the rubber dome 132 is disposed within the hollow portion of the spring 131 and located above the switch 140. The top surface of the rubber dome 132 is lower than the top surface of the spring 131, thereby defining a height difference H3 between the rubber dome 132 and the spring 131. The rubber dome 132 may be an arched protrusion structure containing an annular base portion 133, a dome portion 134, and a cylindrical portion 135. The dome portion 134 extends upwardly in an arched shape from the annular base portion 133, and the cylindrical portion 135 extends upwardly from the dome portion 134. Furthermore, a receiving space 137 is formed inside the dome portion 134, and a pressing projection 136 is disposed in the receiving space 137 and extends toward the switch 140 through the top surface of the dome portion 134. The pressing projection 136 is normally separated from the switch 140. When the keycap 120 is pressed, the dome portion 134 elastically deforms under the pressing force so that the pressing projection 136 contacts the switch 140.

In one embodiment, the outer diameter D1 of the annular base portion 133 is substantially the same as, or within an allowable tolerance of, the inner diameter D2 of the spring 131. When the spring 131 is fitted around the rubber dome 132, the spring 131 closely abuts the annular base portion 133 to achieve a positioning or limiting effect for the spring 131.

Because the deformation mechanism of the rubber dome 132 differs from the linear deformation of the spring 131, the rubber dome 132 does not exhibit a single fixed spring constant. During the initial elastic deformation stage, the spring 131 provides a linear force curve, and together with the preloading interference of the keycap 120, the user experiences a relatively large initial pressing threshold. During subsequent deformation, the combined action of the spring 131 and the rubber dome 132 provides a larger spring constant, allowing the keycap 120 to return to its original position more quickly, making the key suitable for rapid successive key pressing. Therefore, through the dual-stage restoring force mechanism 130 of the present invention, the combination of the spring 131 and the rubber dome 132 provides a two-stage light-to-heavy feedback. This allows the user to press the keycap 120 quickly and smoothly, and allowing the keycap 120 to rebound rapidly, thereby reducing finger fatigue during repetitive key operations, such as in electronic gaming.

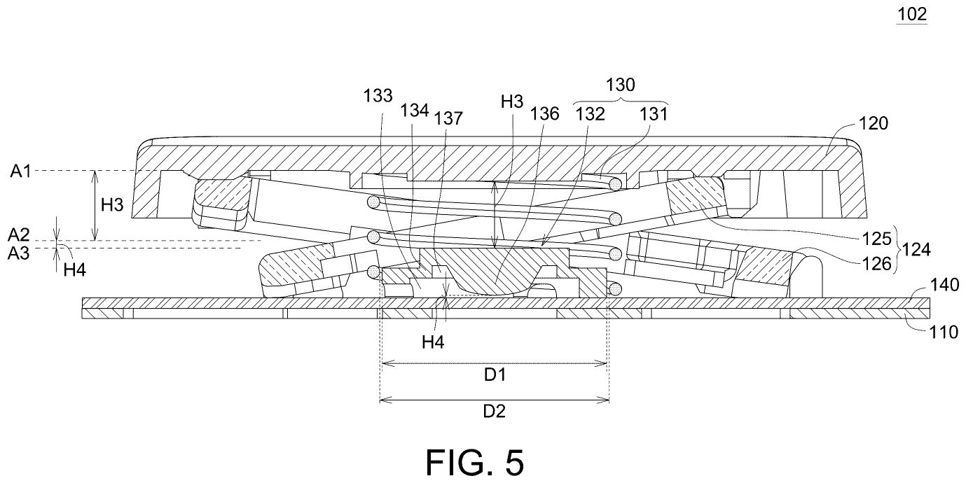

Referring to FIG. 5, a schematic view illustrating a cross-section of a key structure 102 according to another embodiment of the present invention is shown. The key structure 102 is generally similar to the key structures 100 and 101 described above, except that the geometric structure of the rubber dome 132 differs. The following description focuses on the differences; identical parts are omitted for brevity.

Referring to FIG. 5, the rubber dome 132 may be an arched protrusion structure containing an annular base portion 133 and a dome portion 134. The dome portion 134 extends upwardly in an arched shape from the annular base portion 133. Unlike the embodiment shown in FIG. 4, the dome portion 134 in this embodiment does not include the upwardly extending cylindrical portion 135, thus the height difference H3 between the rubber dome 132 and the keycap 120 is increased—for example, by about 0.1 mm or more. In addition, a receiving space 137 is formed inside the dome portion 134, and a pressing projection 136 is disposed within the receiving space 137 and extends toward the switch 140. The pressing projection 136 is normally separated from the switch 140. When the keycap 120 is pressed, the dome portion 134 elastically deforms under the pressing force so that the pressing projection 136 contacts the switch 140. In one embodiment, the distance H4 between the pressing projection 136 and the switch 140 is very small, for example, 0.1 mm or less, so that the user does not perceive a distinct tactile feedback.

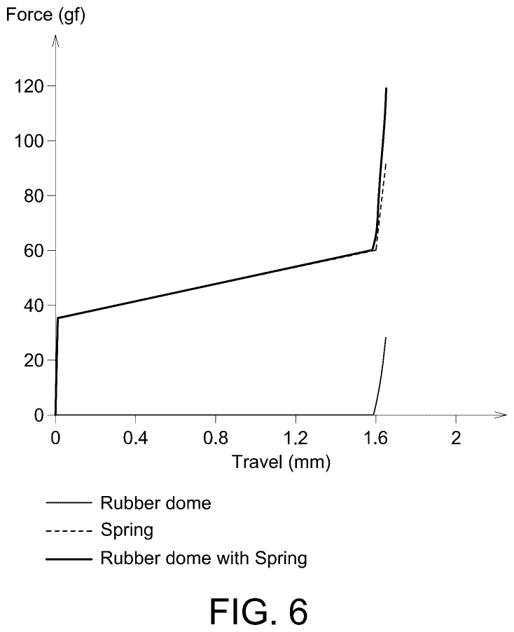

Referring to FIG. 6, FIG. 6 illustrates graphs showing the relationship between the pressing travel and pressing force for the spring 131 and the silicone dome 132 individually, as well as for the combination of the spring 131 and the silicone dome 132 shown in FIGS. 4 and 5. When the keycap 120 is pressed downward from the initial position A1 to the transition position A2—for example, during an initial deformation stage ranging from 0 to 1.6 mm—only the load-displacement characteristic of the spring 131 provides an upward reaction force, while the rubber dome 132 does not contribute any upward force. When the keycap 120 is further pressed beyond the transition position A2 (e.g., beyond 1.6 mm), both the rubber dome 132 and the spring 131 contribute upward forces according to their load-displacement characteristics. Accordingly, the key structure 100 achieves an increased overall spring constant through the combination of the rubber dome 132 and the spring 131. For example, during the initial elastic deformation, the spring 131 provides a linear spring constant, while in the subsequent stage, the rubber dome 132 begins to contribute additional restoring force. At this stage, the combined action increases the overall spring constant, allowing the key structure 101 or 102 to achieve a strong rebound force and enabling the keycap 120 in key structures 101 or 102 to return to its original position in a short time, suitable for rapid successive key pressing.

The combination action of the spring 131 and the rubber dome 132 shown in FIGS. 4 and 5 can produces a force-displacement curve similar to that of a “red-axis” mechanical keyboard switch, where the spring 131 first provides a linear force curve, combined with a preloaded interference of the keycap 120. When the keycap 120 compresses the rubber dome 132, a greater rebound force is subsequently generated, thereby shortening the time required for the keycap 120 to return to its original position.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A key structure, comprising:
a base;
a keycap disposed above the base;
a restoring force mechanism disposed between the base and the keycap, the restoring force mechanism comprising a spring and a rubber dome, wherein the spring is disposed around the rubber dome; and
a switch fixedly disposed between the base and the rubber dome;
wherein, when the keycap is at an initial position, the keycap is separated from the spring and in contact with the rubber dome;
wherein, when the keycap is subjected to a pressing force and moves from the initial position toward the base to a transition position, the keycap contacts the spring; and
wherein, when the keycap moves toward the base beyond a triggering position, the rubber dome actuates the switch to generate a trigger signal.

2. The key structure of claim 1, wherein the rubber dome has a first-stage spring constant and a second-stage spring constant, the first-stage spring constant is greater than the second-stage spring constant, and after the keycap moves from the initial position toward the base to the transition position, the rubber dome transitions from the first-stage spring constant to the second-stage spring constant.

3. The key structure of claim 1, wherein the spring and the rubber dome have a height difference.

4. The key structure of claim 3, wherein a height of the rubber dome is greater than a height of the spring.

5. The key structure of claim 3, wherein the height difference corresponds to a distance between the initial position and the transition position.

6. The key structure of claim 1, wherein the spring has a hollow portion, and the rubber dome is disposed within the hollow portion of the spring and positioned on the switch.

7. The key structure of claim 1, wherein a difference between a downward pressing resistance and a rebound force provided by the combination of the rubber dome and the spring is less than or equal to 5 gram-force.

8. A key structure, comprising:
a base;
a keycap disposed above the base; a restoring force mechanism disposed between the base and the keycap, the restoring mechanism comprising a spring and a rubber dome, the spring being disposed around the rubber dome; and a switch fixedly disposed between the base and the rubber dome, wherein, when the keycap is at an initial position, the keycap is separated from the rubber dome and in contact with the spring; wherein, when the keycap is subjected to a pressing force and moves from the initial position toward the base to a transition position, the keycap contacts the rubber dome; wherein, when the keycap moves toward the base beyond a triggering position, the rubber dome actuates the switch to generate a trigger signal.

9. The key structure of claim 8, wherein the spring and the rubber dome have a height difference.

10. The key structure of claim 9, wherein a height of the rubber dome is less than a height of the spring.

11. The key structure of claim 9, wherein the height difference corresponds to a distance between the initial position and the transition position.

12. The key structure of claim 8, wherein the spring has a hollow portion, and the rubber dome is disposed within the hollow portion of the spring and positioned on the switch.

13. The key structure of claim 8, wherein a difference between a downward pressing resistance and a rebound force provided by the combination of the rubber dome and the spring is less than or equal to 5 gram-force.
